(19) United States
(12) Patent Application Publication
(10) Pub. No.: US 2016/0083107 A1
(43) Pub. Date: Mar. 24, 2016

(54) ALERT MANAGEMENT METHOD

(71) Applicant: THALES, Courbevoie (FR)

(72) Inventors: Sonia VAUTIER, TOULOUSE (FR); Patrick MAZOYER, SAINT-LEON (FR); Bertrand CAUDRON, TOURNEFEUILLE (FR)

(21) Appl. No.: 14/860,480

(22) Filed: Sep. 21, 2015

(30) Foreign Application Priority Data
Sep. 22, 2014 (FR) 1402105

(51) Int. Cl. B64D 45/00

(52) U.S. Cl. CPC B64D 45/00

(57) ABSTRACT

An alert management method implemented by a flight management system for triggering alerts during flight of an aircraft, using a look-up table associating, with each alert, at least one flight parameter and establishing, for each alert and the associated flight parameter, a correspondence between the value of the associated parameter and a plurality of predefined ordered priority levels. The method comprises when an alert is triggered: loading a value of the associated flight parameter, as a function of the state of the aircraft in real time, determining the priority level of the current alert out of the plurality, the priority level being determined by the value and from the look-up table; at regular time intervals and for each active alert, reiterating the preceding steps to determine, for each active alert, an associated priority level that is a function of the state of the aircraft in real time.

### CROSS-REFERENCE TO RELATED APPLICATION

This application claims priority to foreign French patent application No. FR 1402105, filed on Sep. 22, 2014, the disclosure of which is incorporated by reference in its entirety.

### FIELD OF THE INVENTION

The present invention relates generally to the management of alerts on board an aircraft. More particularly, the invention relates to the management of the alerts triggered by a flight management system (FMS), which handles the guiding of an aircraft along a complex trajectory.

### BACKGROUND

The flight management system makes the route to be followed available to the aircrew and available to other embedded systems. This system, among other things, provides navigation assistance, by the display of useful information to the pilots and of alerts, or else by the communication of flight parameters to an automatic pilot system.

FIG. 1 shows a block diagram illustrating the structure of an FMS known from the prior art. A system of FMS type 10 comprises at least the following functions, described in the ARINC 702 standard:
Navigation (LOCNAV) 101, to perform the optimal location of the aircraft as a function of the geolocation means 130 such as satellite geopositioning or GPS, GALILEO, VHF radionavigation beacons, the intertial units. This module communicates with the abovementioned geolocation devices;
Flight plan (FPLN) 102, for inputting the geographic elements that make up the skeleton of the route to be followed, such as the points imposed by the departure and arrival procedures, the waypoints, the air corridors, called airways;
Navigation database (NAVDB) 103, for constructing the geographic routes and the procedures from data included in the bases relating to the points, beacons, interception or altitude legs, etc;
Performance database (PRFDB) 104, containing the aerodynamic and engine parameters of the craft;
Lateral trajectory (TRAJ) 105, for constructing a continuous trajectory from the points of the flight plan, that accords with the aircraft performance and confinement constraints (RNP);
Predictions (PRED) 106, for constructing an optimized vertical profile on the lateral and vertical trajectory. The functions that are the object of the present invention affect this part of the computer;
Guidance (GUID) 107, for guiding the aircraft in the lateral and vertical planes on its three-dimensional trajectory, while optimizing its speed. In an aircraft equipped with an automatic pilot device 11, the latter can exchange information with the guidance module 107;
Digital data link (DATALINK) 108, for communicating with the control centres and other aircraft 13.

Furthermore, the flight management system has a human-machine interface 12 comprising, for example, a keyboard and a display screen, or else simply an interactive display screen. This interface typically comprises one or more screens for, on the one hand, inputting and modifying the route that the aircraft will follow as a function of its flight plan, and, on the other hand, for displaying various messages to the pilots.

Hereinbelow, we will call the alert messages delivered by the FMS simply “alert messages”. These alerts are linked to the various important information items to be announced to the pilots concerning the various functionalities of the FMS mentioned above: navigation, flight plan, navigation database, etc. In certain cases, these alert messages relate to data to be provided by the pilot or require a particular action on the part of the pilot.

Currently, in addition to the FMS, the aircraft can be equipped with other systems handling crew assistance functions: an alert management system, or FWS for Flight Warning System, and/or a standalone monitoring system, of TAWS type standing for “Terrain Awareness Warning System,” the aim of which is to prevent risks linked to the environment of the aircraft, in particular the risks of collision. The alerts generated by these systems are managed independently. The present invention does not deal with the alert messages delivered by these systems, and deals only with the alert messages delivered by the FMS.

According to the prior art, the messages are triggered and displayed on a screen of the FMS as they occur over time, without distinction.

FIG. 2 illustrates an example of an FMS screen 21 on which the last message to have arrived 20 is displayed. When the next message arrives, it “drives away” the message displayed and replaces it. On another screen or another page, accessible from the page of the screen 21, illustrated in FIG. 3, the list of the current alert messages is displayed, the messages being arranged in order of arrival.

The existing solutions enabling the crew to distinguish one alert message that is more essential than another are:

Colour code: These days, a colour code is used to distinguish the alert level of a message but, once assigned, this colour is fixed regardless of the real-time context of the aeroplane.

Display on multiple screens: Certains messages are displayed on multiple screens in order for the pilot to be better alerted as to the identified problem. FIG. 4 illustrates an additional FMS screen 41, called Navigation Display, on which the pilot is reminded of the last message to arrive 40.

These messages are therefore heterogeneous in terms of processing priority, and often not explained by their wording. Furthermore, they do not take account of the context in which the aircraft is moving. Thus, there is currently a lack of conciseness, of synthesis and of legibility of the essential information to be dealt with compared to other information according to the flight context, which, in a certain number of operational situations, has the effect of generating an increase in the work load of the pilot. Furthermore, these messages do not directly guide the pilot towards the actions expected to deal with the origin of the alert.

One aim of the invention is to mitigate the abovementioned drawbacks by proposing an alert management method that makes it possible to prioritise alerts according to the aeroplane context.

### SUMMARY OF THE INVENTION

According to a first aspect, the subject of the present invention is an alert management method implemented by a flight management system suitable for triggering alerts during the flight of an aircraft, the alerts being predefined, a triggered alert not yet dealt with by a pilot being called active alert, the method using a look-up table:

associating, with each alert, at least one flight parameter exhibiting a value that is a function of a state of the aircraft, the value being likely to change during the flight, and

establishing, for each alert and the associated flight parameter, a correspondence between the value of the associated parameter and a plurality of predefined ordered priority levels, the priority level being a function of the value, the method comprising the steps consisting:

when an alert is triggered, in:

loading a value of the associated flight parameter, that is a function of the state of the aircraft in real time,

determining the priority level of the current alert out of said plurality, said priority level being determined as a function of said value and from said look-up table, at regular time intervals and for each active alert, in:

reiterating the preceding steps so as to determine, for each active alert, an associated priority level that is a function of the state of the aircraft in real time.

According to a preferred embodiment, the method further comprises a step consisting in generating, at regular time intervals, a dynamic priority table comprising a list of active alerts and the associated priority level.

According to one embodiment, the method comprises a step consisting in generating, when an alert is triggered, an associated alert message.

Advantageously, the method comprises a step consisting in generating, at regular time intervals, a dynamic message table comprising the messages corresponding to the active alerts and the associated priority level.

Advantageously, the method further comprises a step consisting in displaying, to a pilot, at least the messages associated with the active alerts of highest priority level.

Preferentially, the display step comprises the display of a plurality of messages associated with active alerts and ordered by priority level.

Advantageously, the value of the priority level or levels is immediately identifiable by the pilot.

According to one embodiment, the display step comprises an additional step of display of additional information relating to the active alert corresponding to a displayed message.

According to one embodiment, the display step comprises an additional step making it possible to delete a displayed message and deactivate the corresponding alert.

Advantageously, the display step comprises, for each displayed message, the display of the time of triggering of the corresponding alert.

Advantageously, the content of a displayed message corresponds to an information item or an action to be performed by the pilot.

According to one embodiment, the display step comprises, for each displayed message whose content corresponds to an action, the display of at least one field making it possible for the pilot to perform at least a part of said action.

According to another embodiment, the display step comprises, for each displayed message whose content corresponds to an action, an additional step of display of a page comprising fields making it possible for the pilot to perform at least a part of said action.

As a variant, the display step further consists in displaying the same content on two different screens, allowing for an independent use of each content on each display.

Advantageously, a first screen is visible to a pilot and a second screen is visible to a co-pilot, the pilot being able to select, on the first screen, a first alert message and deal with the corresponding alert, and the co-pilot being able to select, on a second screen, a second alert message and deal with the corresponding alert.

According to another embodiment, the wording of an alert message depends on the context in which the aircraft is moving.

According to another aspect, the invention relates to an alert management device suitable for triggering alerts during the flight of an aircraft, a triggered alert not yet dealt with by a pilot being called active alert, the device comprising:

a list of alerts, and

a look-up table:

associating, with each alert, at least one flight parameter exhibiting a value that is a function of a state of said aircraft, the value being likely to change during the flight, and

establishing, for each alert and the associated flight parameter, a correspondence between the value of the associated parameter and a plurality of predefined ordered priority levels, the priority level being a function of the value, and

a module configured to load a value of the associated flight parameter, that is a function of the state of the aircraft in real time, to trigger the alerts and to determine a priority level for a current alert out of said plurality, said priority level being determined as a function of the value and from the look-up table, when an alert is triggered and at regular time intervals for each active alert, so as to determine, for each active alert, an associated priority level that is a function of the state of the aircraft in real time, and configured to generate, at regular time intervals, a dynamic priority table comprising a list of the active alerts and the associated priority level, and

a module for generating an alert message, when an alert is triggered, configured to generate, at regular time intervals, a dynamic message table comprising the messages corresponding to the active alerts and the associated priority level,

at least one display configured to display, to a pilot, at least the messages associated with the active alerts of highest priority level.

Advantageously, at least one display is further configured to display a plurality of messages associated with active alerts and ordered by priority level.

According to another aspect, the invention relates to a flight management system FMS comprising the device according to the invention.

According to a last aspect, the invention relates to a computer program product comprising code instructions making it possible to perform the steps of the method according to the invention.

### BRIEF DESCRIPTION OF THE DRAWINGS

Other features, aims and advantages of the present invention will become apparent on reading the following detailed description and in light of the attached drawings given by way of nonlimiting examples and in which:

FIG. 1, already mentioned, represents a block diagram illustrating the structure of an FMS known from the prior art,

FIG. 2, already mentioned, illustrates an exemplary FMS screen according to the prior art,

FIG. 3, already mentioned, illustrates an another exemplary FMS screen according to the prior art,

FIG. 4, already mentioned, illustrates an FMS screen called Navigation Display according to the prior art,

FIG. 5 schematically represents the method according to the invention,

FIG. 6 illustrates a preferred mode of implementation of the method according to the invention,

FIG. 7 illustrates a mode of implementation of the method according to the invention,

FIGS. 8a and 8b illustrate an implementation whereby the highest priority message appears on a main page (FIG. 8a) and the list of the active alerts appears on another page (FIG. 8b),

FIG. 9 illustrates a mode of implementation of the method according to the invention,

FIG. 10 illustrates a first variant of a mode of implementation of the invention,

FIG. 11 illustrates a second variant of this mode of implementation of the invention,

FIG. 12 illustrates a device according to the invention.

### DETAILED DESCRIPTION

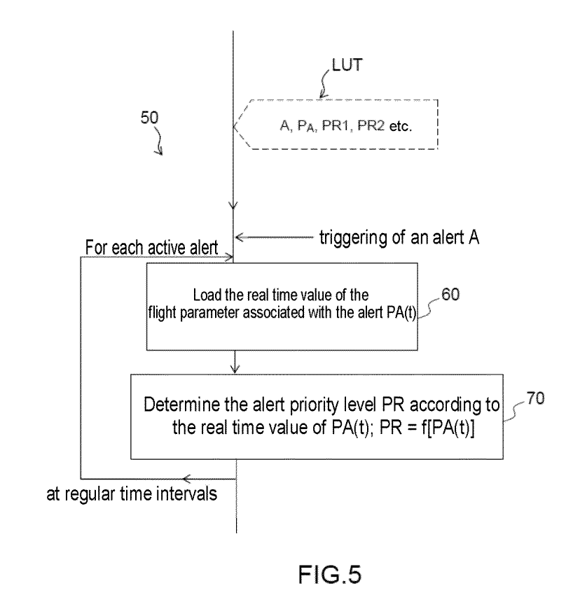

FIG. 5 schematically represents the alert management method 50 implemented by the FMS according to the invention. The method 50 is suitable for triggering alerts during the flight of an aircraft, the alerts being predefined in a navigation database BD.

The alerts generated by the FMS deal with the functionalities of the FMS, which are primarily alerts linked to navigation, such as, for example:

Alerts linked to the computation of the position (LOCNAV block)
Invalid position
Position too imprecise
Sensors failed or drifting (e.g. GPS, IRS, etc)
Alignment of the inertial units problematical
Estimated position different from expected position (comparison with the runway threshold entered in the FPLN block for example)
Radionavigation beacons linked to the flight plan not available
   Alerts linked to the computation of the flight plan (FPLN block)
Problem constructing the flight plan (e.g. terminal procedures not mutually consistent)
Flight plan storage capacity exceeded
Flight initialization problem (incorrect input of the weights and centrings)
   Alerts linked to the navigation database (NAVDB block)
Items input in the database (waypoint, airport, radionavigation beacon, etc)
   Alerts linked to the computation of the trajectory (TRAJ and PRED blocks)
Aeroplane envelope problems: cruising level too high and not flyable, untenable altitude/speed/time constraints
Predicted consumption problems: fuel on arrival too low
Problems computing trajectory relative to lateral constraints of RNP type
   Alerts linked to the locking of the aeroplane on the trajectory (GUID block)
Problems following the lateral or vertical trajectory by guidance
Arrival in an imposed procedure with speed too high (e.g. holding patterns)
   Alerts linked to air/ground communications (DATALINK block)
Clearance not decodable (syntax errors)
Clearance not insertable (elements not in NAVDB, mutually inconsistent, absent, etc)
Communication problem between the FMS and the air-ground communication system (CMU for communication management unit)

All of the possible alerts are coded in the FMS, and the conditions for triggering of an alert are predefined, and correspond to the conjunction of certain flight parameters such as, for example:

the state of the aircraft associated with its position, the flight phase,

a flight condition, for example the expected level of precision (RNP) as a function of the position of the aircraft,

a configuration of the aircraft, for example the presence of equipment, the positioning of the leading edges and/or control surfaces, an engine failure.

The alerts can be:

predefined in a database, or

loaded on starting up the aeroplane systems, for example transferred from a ground tool (airline for example), or

directly incorporated in the FMS software, or

hosted by an alert-concentrating third-party system, for example a system hosting the alerts of a number of other systems such as the TAWS, FWS.

A flight parameter is likely to change during the flight.

A triggered alert needs to be dealt with. Once dealt with by the pilot, it becomes obsolete. An alert may also become obsolete at a certain moment, because of the trend of one of its triggering parameters. A triggered alert not yet dealt with by a pilot is called active alert. When the parameters which have generated the active alert change and the triggering conditions are no longer fulfilled, the FMS system can spontaneously delete an active alert (it is then eliminated, even without action from the pilot).

The implementation of the method according to the invention involves a look-up table LUT.

First of all, the LUT associates with each alert A at least one flight parameter P_{A}, which exhibits a value that is a function of the state of the aircraft, the value being likely to change during the flight.

Furthermore, for each alert and the at least one associated flight parameter (A, P_{A}), the LUT produces a correspondence between the value of the associated parameter and a plurality of predefined ordered priority levels, for example PR1, PR2, PR3, the priority level being a function of this value.

The alert is triggered only when the associated flight parameter takes certain values.

The look-up table LUT which links these alerts to the triggering parameters and to the priority levels can be:

stored in a database, or

loaded on starting up the aeroplane systems, for example transferred from a ground tool (airline for example), or

directly incorporated in the FMS software or in a multi-system alert concentrator.

It should be noted that the triggering of an alert is not necessarily linked to the parameter used to define the priority level.

A priority level is assigned as a function of the value of a parameter associated with the priority level. Table I below illustrates the LUT and gives examples of alert A, of associated flight parameter P_{A} and of priority levels that are determined as a function of the value of the associated parameter. In the example, the LUT comprises at most 3 possible priority levels, and all the alerts listed do not necessarily involve all three 3 levels.

TABLE I
example of alert/associated flight
parameter/priority level look-up table

| | Corresponding | Associated flight | Priority | Priority | Priority |
|---|---|---|---|---|---|
| | message | parameter | level 1 | level 2 | level 3 |
| Alert A | M_{A} | P_{A} | PR1 | PR2 | PR3 |
| The crew has not entered | ENTER QNH | Flight phase | APPROACH | DESCENT phase | CRUISE phase is |
| the pressure at sea level | | | phase is active | is active | active |
| (QNH) making it possible to | | | | | |
| set the aeroplane altitude | | | | | |
| The crew has not entered | ENTER APP | Distance from | Less than 50 NM | Less than 200 NM | |
| the data necessary for the | DATA | arrival | from arrival | from arrival | |
| computation of the speed of | | | | | |
| approach to the arrival | | | | | |
| runway (wind, ground | | | | | |
| temperature, QNH) | | | | | |
| The crew has not adjusted | CHECK SPD | Engine state | Engine out | | Full Engine |
| its speed to observe a | SETTING | | | | |
| procedure | | | | | |
| The cruising level of the | CURRENT CRZ | Altitude | Below FL100 | Between FL 200 | Above FL 200 |
| aircraft is above the | FL ABOVE | | | and FL 100 | |
| recommended maximum | MAX ALT | | | | |
| levels | | | | | |
| The aeroplane position is | CHECK | Position in | RNP 0.1 | RNP between RNP | RNP >0.3 |
| affected by an uncertainty | POSITION | relation to level | | 0.1 and 0.3 | |
| | | of accuracy | | | |
| The fuel predicted at | CHECK MIN | Fuel state | EFOB at Dest <= | EFOB at Dest + 10 | EFOB at Dest + 20 |
| destination is less than the | FUEL AT DEST | | MIN DEST FUEL | T > MIN DEST | T > MIN DEST FUEL |
| regulatory reserve | | | | FUEL | |
| The type of approach | CHECK APP | Distance from | Less than 20 NM | | More than 20 NM |
| chosen by the crew does | SEL | FAF | from FAF | | from FAF |
| not correspond to the | | | | | |
| frequencies of the | | | | | |
| radionavigation beacons | | | | | |
| used | | | | | |
| The position of the inertial | CHECK IRS | GPS equipment | Without GPS | | Within GPS |
| units is far from the | POSITION | | navigation | | navigation |
| theoretical position | | | | | |

The method 50 according to the invention comprises the following steps:

When an alert A is triggered, called current alert, a first step 60 loads a value of the associated flight parameter, as a function of the state of the aircraft in real time, then a second step 70 determines the priority level of the current alert out of the plurality of priority levels, as a function of the value of the associated flight parameter and from the look-up table LUT.

The FMS can generate these different values by internal computations, or by receiving a parameter from an external system to which it is interfaced.

For example, for the alert linked to the message “ENTER QNH”, the FMS sees, internally, that the data to be inserted into its system via the Human-Machine interfaces of the FMS have not been defined (the predicted pressure at sea level has not been entered). This is an internal datum.

In other architectures, this datum can be entered by the crew or from outside on another system via other interfaces. The FMS has to simply check that a defined and valid value has been entered. The parameters that make it possible to set the priority are also computed by the FMS for this alert: it is in fact the FMS which generates the flight phases (CRUISE, DESCENT, APPROACH).

In another example “CHECK SPD SETTING”, the triggering parameter is the leg currently being flown (or soon to be flown) by the FMS, contained in the flight plan FPLN. It is therefore an internal datum. By contrast, the parameters that make it possible to compute the priority level are the states of the engines (at least 1 engine failed (ENGINE OUT) or all engines operating (FULL ENGINE)), read on the aeroplane engine management equipment.

The steps 60 and 70 are then repeated at regular time intervals and for each active alert, so as to determine, for each active alert, an associated priority level that is a function of the state of the aircraft in real time.

“Regular time interval” should be understood to mean intervals that are not necessarily equal, the frequency of which is likely to vary as a function of the flight phases, or of a particular situation of the aircraft.

Typically, the events such as pilot inputs on the HMI automatically generate an interrogation.

The computations of distance, of altitude, of engine state, or other parameter of the equations of the mechanics of the flight are generally monitored with a high frequency (typically every 0.1 sec).

Parameters like the prediction of the fuel on arrival (message CHECK MIN FUEL AT DEST) are typically computed every 30 seconds as long as the aeroplane is far from its destination (in cruising phase for example) and more regularly when the aeroplane approaches the destination (typically every 10 to 20 seconds in DESCENT or APPROCHE phase).

The method 50 thus makes it possible to assign each active alert a priority level that is a function of the real time state of the aircraft, which makes it possible to distinguish the alerts that have to be dealt with rapidly from those that can be delayed.

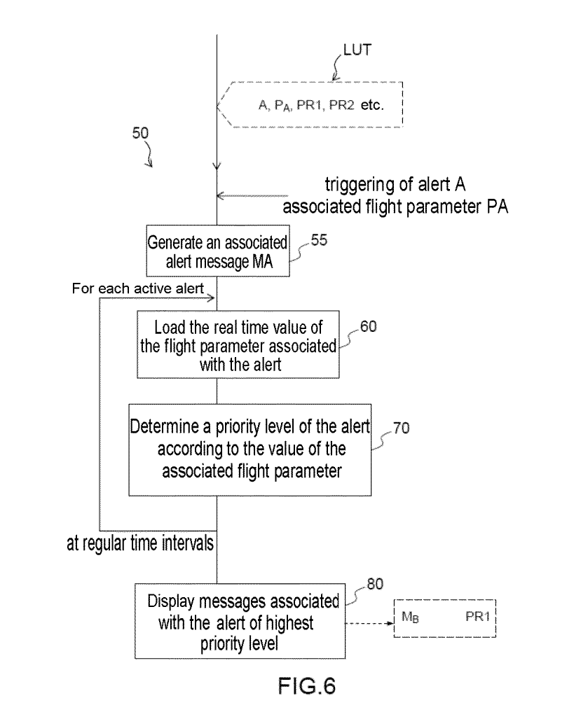

According to a preferred mode of implementation illustrated in FIG. 6, the method further comprises a step 55 of generation, when an alert A is triggered, of an associated alert message M_{A} having a standardized wording.

Preferentially, the method 50, also illustrated in FIG. 6, also comprises a step 80 of display to the pilot of at least the messages associated with the active alerts of highest priority level. The highest priority level PRmax out of the active alerts is not necessarily the highest priority level in absolute terms PR1. It is the relative highest priority level out of the different levels of the active alerts. The highest priority alert (or alerts) is (are) thus highlighted relative to the others.

Preferentially, to eliminate any ambiguity, the priority level corresponding to PRmax (PR1, PR2 or PR3 in the example) is signalled to the pilot, or is immediately identifiable by the pilot, in the form of a colour coding of the predefined messages, for example red for PR12, orange for PR2 and yellow for PR3 or being displayed alongside the corresponding message.

The method 50 according to this mode of implementation effectively, concisely and synthetically guides the pilot towards the essential information to be dealt with/checked, by an alert prioritization mechanism based on the aeroplane context and an ad doc display. The pilot no longer needs to intuitively grasp the context to prioritize the alerts him or herself. This filtering of the alerts constitutes a decision aid for the pilot for dealing with the priority actions, which saves on the workload for him or her. It makes it possible to highlight, at the right moment, one alert with respect to another which can wait to be dealt with later, given the current situation of the aircraft.

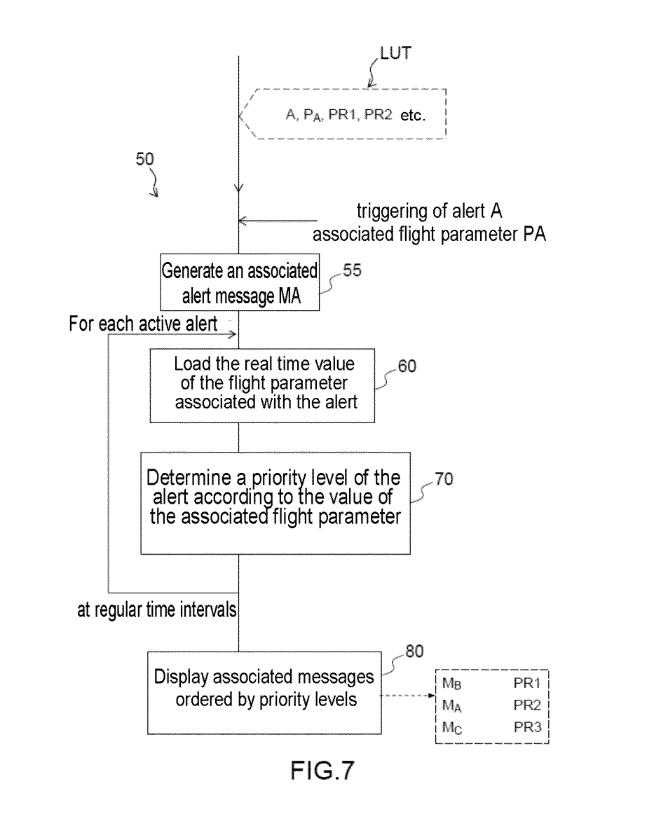

According to a mode of implementation illustrated in FIG. 7, the display step 80 comprises the display of a plurality of messages associated with active alerts ordered by priority level.

Preferentially, to eliminate any ambiguity, the corresponding priority levels (PR1, PR2, PR3 in the example) are signalled to the pilot, that is to say that, for each active alert displayed, the corresponding priority level is immediately identifiable by the pilot.

Preferentially, all of the messages corresponding to the active alerts are displayed in the form of an ordered list LO on a page, typically accessible from a current page.

Preferentially, the list LO is displayed on the MFD (Multi-Function Display) which is one of the HMIs of the FMS.

The pilot accessing this list thus has an overview of all of the active alerts, arranged by priority.

Thus, one implementation consists in the display, on the main display of the FMS (for example an MFD), of the highest priority message on a main page, and the display of the list LO on another page accessible from this main page on the main display and/or on another display of the FMS (such as the Navigation Display ND, or Primary Flight Display PFD).

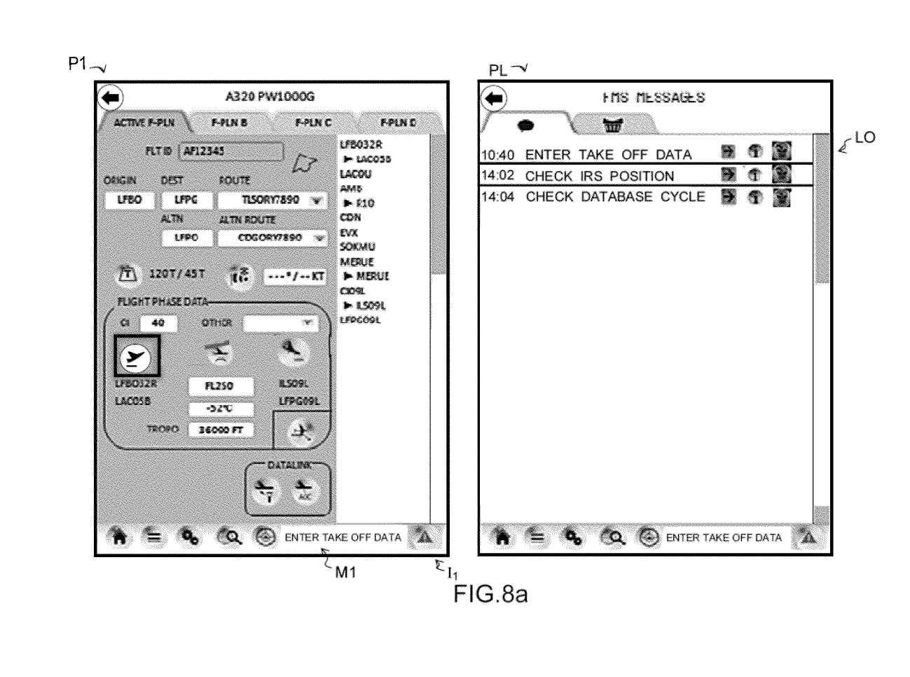

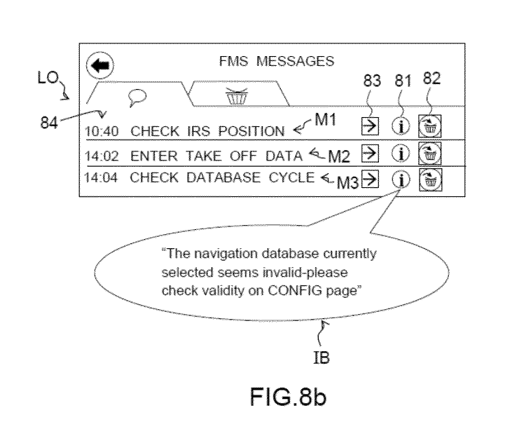

An example of this implementation is illustrated in FIG. 8.

FIG. 8a illustrates the main page P1 which contains, at the bottom, the highest priority message M1 and, alongside, an icon I1 making it possible to access a page PL containing the list LO of all the active messages, arranged by priority. FIG. 8b illustrates different variants associated with the display of the list LO. The 3 messages M1, M2 and M3 corresponding respectively to the alerts A1, A2 and A3 appear in order of priority. The coding here is, by way of example, produced by a colour code on the characters of the message. The message M1 of priority PR1 is coded with a colour C1, whereas the messages M2 and M3, of priority PR2, are coded with a colour C2.

According to a first variant, the display step comprises an additional step of display of additional information relating to the active alert corresponding to a displayed message.

For example, the “information” icon 81 makes it possible to show a text IB giving complementary and more precise information on the message concerned than the wording of the message. This textual help makes it possible to reduce the pilot training time on the system and reduce his or her workload, by simplified access to the information.

According to a second variant, the display step comprises an additional step making it possible to delete a displayed message and deactivate the corresponding alert. For example, the deletion is executed using a “dustbin” icon 82. For a touch screen, another variant is to select and then drag the message to a point on the screen. This deletion is applied by the choice of the pilot, when he or she has dealt with the alert, or when he or she considers that it has become obsolete.

According to a third variant, the display step comprises, for each displayed message, the display 84 of the time of triggering of the corresponding alert.

These different variants may of course be combined.

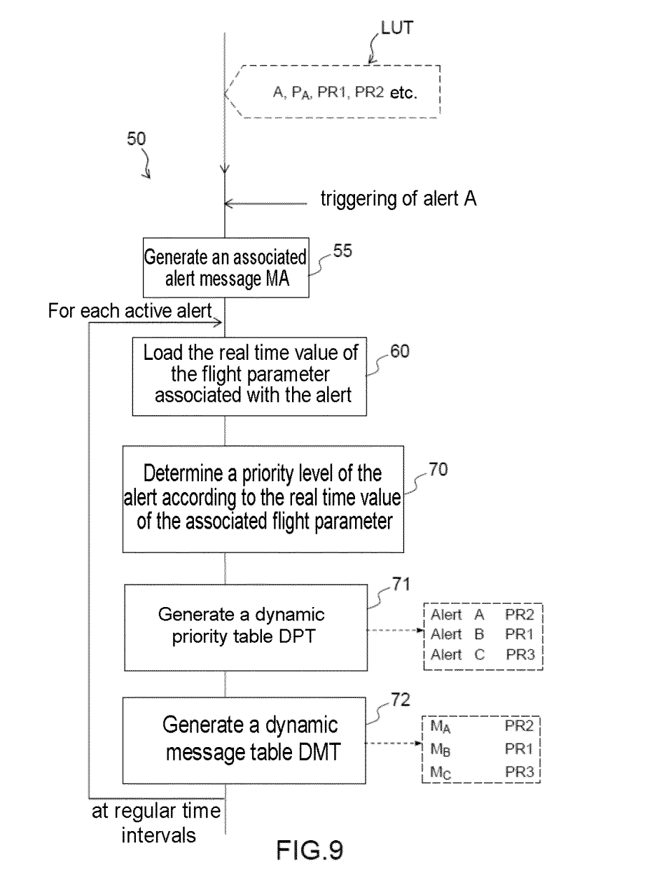

According to a mode of implementation illustrated in FIG. 9, the method 50 further comprises a step 71 consisting in generating, at regular time intervals, a dynamic priority table DPT comprising a list of the active alerts and of the associated priority level. Preferentially, the method also comprises a step 72 consisting in generating, at regular time intervals, a dynamic message table DMT comprising the messages corresponding to the active alerts and the associated priority level.

Among the alert messages displayed, some have a content corresponding to an information item or an action to be performed by the pilot. One drawback is that the wording of these messages uses a restricted vocabulary.

According to one mode of implementation, the display step 80 comprises, for each displayed message whose content corresponds to an action, the simultaneous display of at least one field making it possible for the pilot to perform at least a part of this action. These are for example fields displaying parameters to be checked by the pilot or fields in which the pilot has to insert parameters.

According to another preferred mode of implementation, the display step 80 comprises, for each displayed message whose content corresponds to an action, an additional step of display of a page comprising at least one field making it possible for the pilot to perform at least a part of the action.

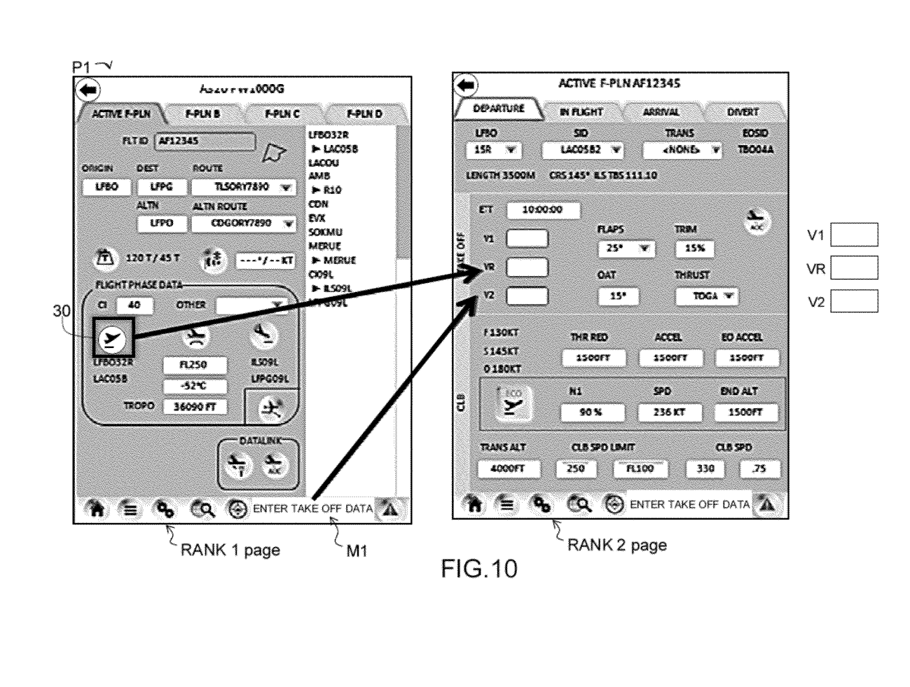

A first variant is the display on a secondary page, called RANK 2 page, directly from the main page called RANK 1 page displaying the message of highest priority level, of fields V1, V2 and VR to be completed, as illustrated in FIG. 10. The point 30 of the display that allows access to these fields is highlighted, for example, by a coloured outline.

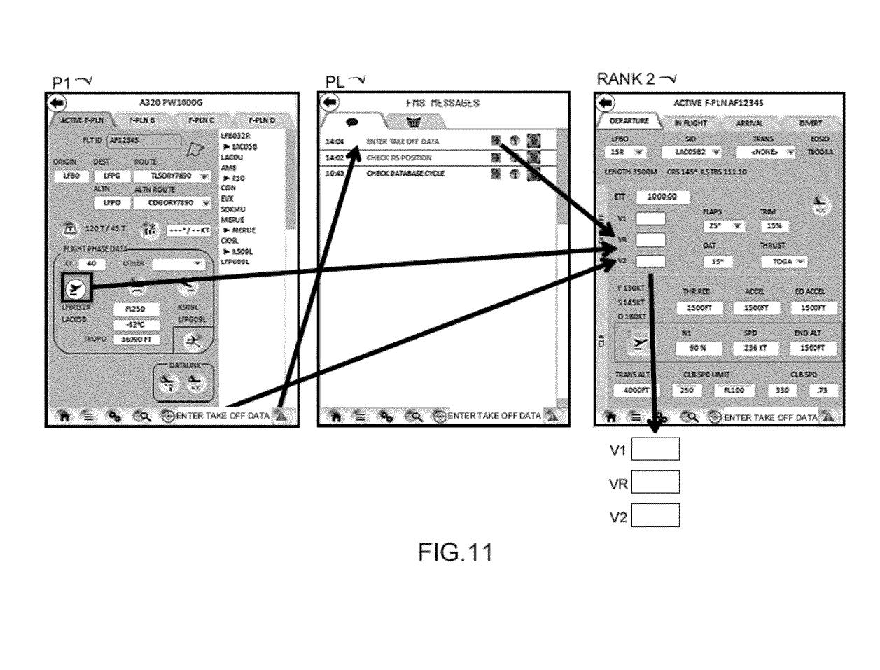

A second variant is the display of the RANK 2 page from the PL page displaying the list of the messages, as illustrated in FIG. 11. The display of the RANK 2 page is obtained for example using an icon 83 illustrated in FIG. 9b.

These two variants can of course be combined, providing different ways of accessing the fields of interest.

The categorization of pages, combined with the display of the fields to be completed or checked, with simplified access according to the invention, enhances the legibility of the alerts and of the associated actions/impacts, which simplifies the work of the pilot.

The displays are preferentially incorporated in the MFD HMI pages of the FMS. Some messages may also be displayed on other screens of the FMS such as the ND or the PFD, even sent to third-party message concentration systems like the FWS or an EFB (Electronic Flight Bag).

According to one embodiment, the display step 80 further consists in displaying the same content on two different screens, allowing for independent use of each content on each display.

Preferentially, a first screen is visible to a pilot and a second screen is visible to a co-pilot, the pilot being able to select, on the first screen, a first alert message and deal with the corresponding alert, and the co-pilot being able to select, on a second screen, a second alert message and deal with the corresponding alert.

Two alert messages are thus managed simultaneously and independently, which results in greater efficiency in dealing with the alerts.

According to a variant, the wording of an alert message depends on the context in which the aircraft is moving. This additional level of precision makes it possible to improve the understanding of the message by the crew, and speed up its recognition.

For example, the message “CHECK SPD SETTING” is ambiguous because it may refer to a number of flight procedures. To remedy this:
In the case of entering into a holding pattern, a “CHECK SPD SETTING DUE TO HOLD” is displayed.
In case of arrival in a search procedure (Search and Rescue SAR), a message CHECK SPD SETTING DUE TO SAR is displayed. In both cases in fact, a particular speed must be observed to perform the manoeuvre.

Advantageously, the target speed value is displayed alongside the message to speed up its recognition.

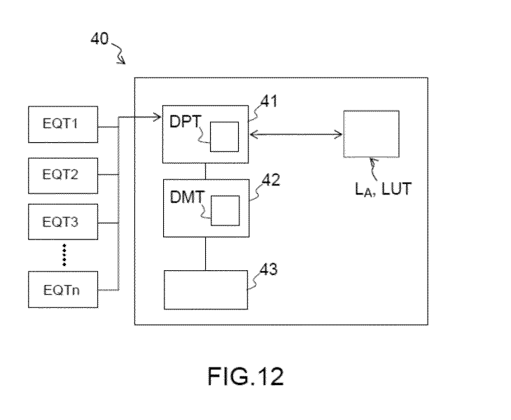

According to another aspect, the invention relates to a device schematically represented in FIG. 12.

The alert management device 40 is suitable for triggering alerts during the flight of an aircraft, a triggered alert not yet dealt with by a pilot being called active alert.

The device 40 comprises:

a list of alerts L_{A}, and

a look-up table LUT:
associating, with each alert A, at least one flight parameter P_{A} exhibiting a value that is a function of a state of said aircraft, said value being likely to change during the flight, and
establishing, for each alert and the associated flight parameter, a correspondence between the value of the associated parameter and a plurality of predefined ordered priority levels PR1, PR2, PR3, etc, the priority level being a function of the value.

The device 40 further comprises a module 41 configured to load a value of the associated flight parameter, that is a function of the state of the aircraft in real time, to trigger the alerts, and to determine the priority level for the current alert out of the plurality of priority levels, the priority level being determined as a function of the value and from the look-up table LUT. This determination is made when an alert is triggered and at regular time intervals for each active alert, so as to determine, for each active alert, an associated priority level that is a function of the state of the aircraft in real time. The module 40 is further configured to generate, at regular time intervals, a dynamic priority table DPT comprising a list of the active alerts and the associated priority level.

The device 40 also comprises a module 42 for generating an alert message M_{A}, when an alert A is triggered, configured to generate, at regular time intervals, a dynamic message table DMT comprising the messages corresponding to the active alerts and the associated priority level.

Finally, the device 40 comprises at least one display 43 configured to display, to a pilot, at least the messages associated with the active alerts of highest priority level PRmax.

Advantageously, the display 43 is further configured to display a plurality of messages associated with active alerts ordered by priority level.

Advantageously, the display is configured to display part or all of said dynamic priority DPT and dynamic message DMT tables.

In one implementation, all of the modules are incorporated in the FMS. The detections of parameters Pa can be made at the level of the components which manage the function attached to these parameters (for example the aeroplane speed checks relative to the procedure speed for the “CHECK SPD SETTING” can be performed by the GUID component which manages the speed control of the aeroplane. The management of parameters concerning the priority levels PR1, PR2, PR3 is performed by the component which manages the datum (GUID also knows the state of the engines for the CHECK SPD SETTING).

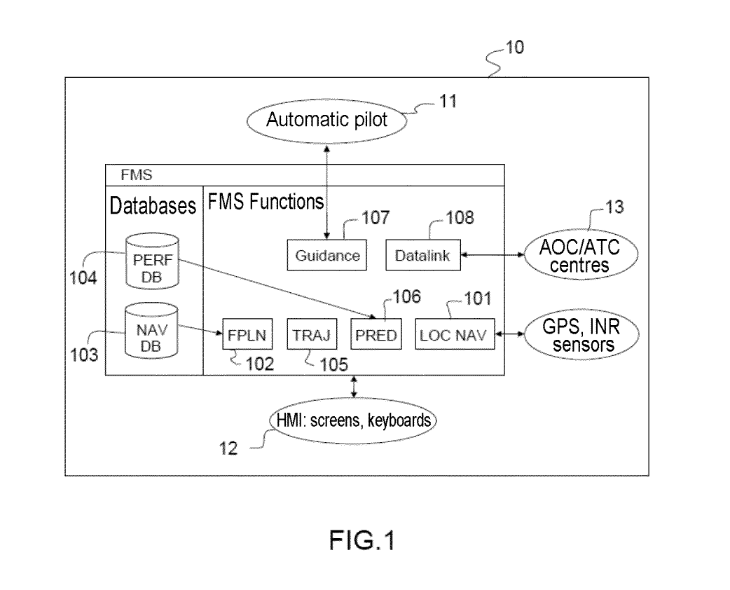

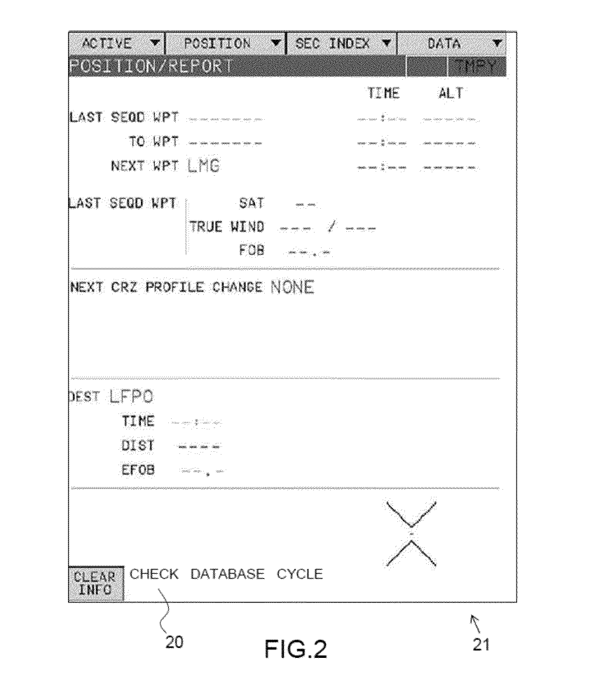

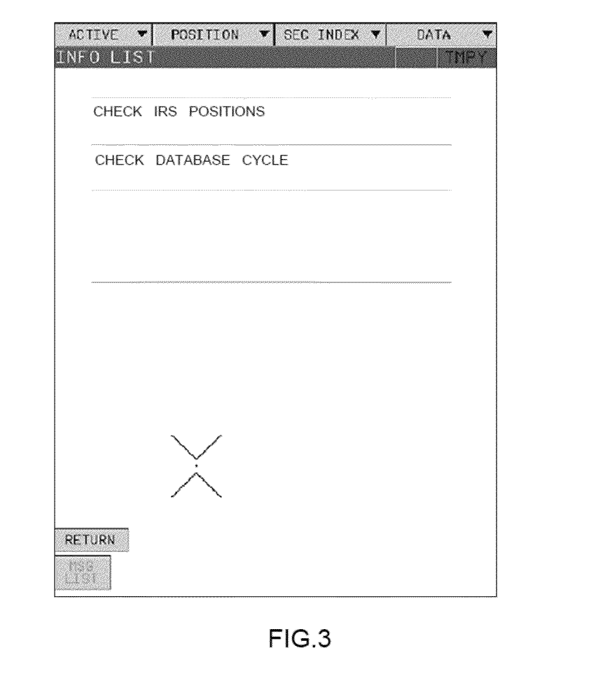

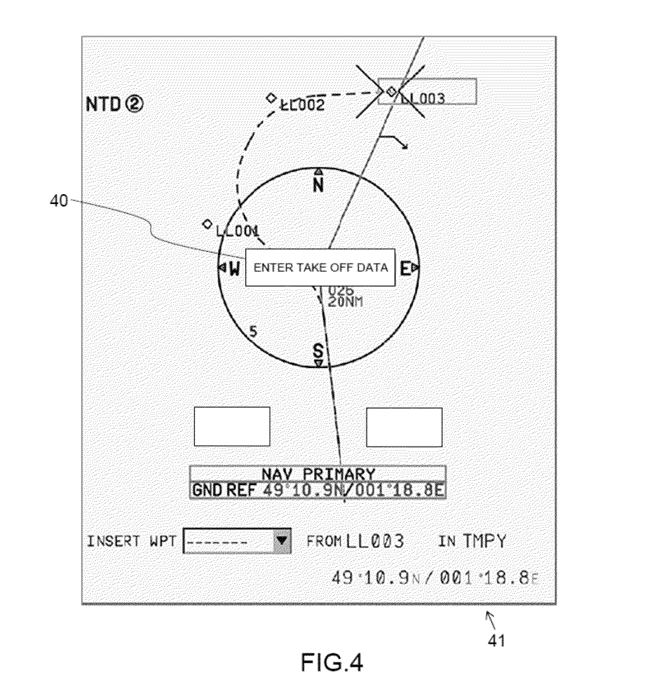

In another implementation, the HMI component (human-machine interface 12 of FIG. 1) manages the parameters and the priority levels.

In another implementation, the parameters Pa, PR1, PR2, PR3 are managed by an event concentrator to be developed in the FMS.

In another implementation, the parameters Pa, PR1, PR2, PR3 are managed by a system external to the FMS, such as, for example, an FWS.

According to another aspect, the invention relates to a flight management system FMS comprising the device 40 according to the invention.

According to a last aspect, the invention relates to a computer program product, the computer program comprising code instructions making it possible to perform the steps of the method according to the invention.

1. An alert management method implemented by a flight management system suitable for triggering alerts during the flight of an aircraft, the alerts being predefined, a triggered alert not yet dealt with by a pilot being called active alert,
said method using a look-up table:
associating, with each alert, at least one flight parameter exhibiting a value that is a function of a state of said aircraft, said value being likely to change during the flight, and
establishing, for each alert and the associated flight parameter, a correspondence between the value of the associated parameter and a plurality of predefined ordered priority levels, said priority level being a function of said value, said method comprising the steps comprising:
when an alert is triggered, in:
loading a value of the associated flight parameter, that is a function of the state of the aircraft in real time,
determining the priority level of the current alert out of said plurality, said priority level being determined as a function of said value and from said look-up table,
at regular time intervals and for each active alert, in:
reiterating the preceding steps so as to determine, for each active alert, an associated priority level that is a function of the state of the aircraft in real time.

2. The method according to claim 1, further comprising a step consisting in generating, at regular time intervals, a dynamic priority table comprising a list of active alerts and the associated priority level.

3. The method according to claim 1, comprising a step consisting in generating, when an alert is triggered, an associated alert message.

4. The method according to claim 3, comprising a step consisting in generating, at regular time intervals, a dynamic message table comprising the messages corresponding to the active alerts and the associated priority level.

5. The method according to claim 3, further comprising a step consisting in displaying, to a pilot, at least the messages associated with the active alerts of highest priority level.

6. The method according to claim 5, in which the display step comprises the display of a plurality of messages associated with active alerts and ordered by priority level.

7. The method according to claim 5, in which the value of the priority level or levels is immediately identifiable by the pilot.

8. The method according to claim 5, in which the display step comprises an additional step of display of additional information relating to the active alert corresponding to a displayed message.

9. The method according to claim 5, in which the display step comprises an additional step making it possible to delete a displayed message and deactivate the corresponding alert.

10. The method according to claim 5, in which the display step comprises, for each displayed message, the display of the time of triggering of the corresponding alert.

11. The method according to claim 5, in which the content of a displayed message corresponds to an information item or an action to be performed by the pilot.

12. The method according to claim 5, in which the display step comprises, for each displayed message whose content corresponds to an action, the display of at least one field making it possible for the pilot to perform at least a part of said action.

13. The method according to claim 5, in which the display step comprises, for each displayed message whose content corresponds to an action, an additional step of display of a page comprising fields making it possible for the pilot to perform at least a part of said action.

14. The method according to claim 5, in which the display step further consists in displaying the same content on two different screens, allowing for an independent use of each content on each display.

15. The method according to claim 14, in which a first screen is visible to a pilot and a second screen is visible to a co-pilot, the pilot being able to select, on the first screen, a first alert message and deal with the corresponding alert, and the co-pilot being able to select, on a second screen, a second alert message and deal with the corresponding alert.

16. The method according to claim 5, in which the wording of an alert message depends on the context in which the aircraft is moving.

17. An alert management device suitable for triggering alerts during the flight of an aircraft, a triggered alert not yet dealt with by a pilot being called active alert, said device comprising:
a list of alerts, and
a look-up table:
associating, with each alert, at least one flight parameter exhibiting a value that is a function of a state of said aircraft, said value being likely to change during the flight, and
establishing, for each alert and the associated flight parameter, a correspondence between the value of the associated parameter and a plurality of predefined ordered priority levels, said priority level being a function of said value, and
a module configured to load a value of the associated flight parameter, that is a function of the state of the aircraft in real time, to trigger the alerts and to determine a priority level for a current alert out of said plurality, said priority level being determined as a function of said value and from said look-up table, when an alert is triggered and at regular time intervals for each active alert, so as to determine, for each active alert, an associated priority level that is a function of the state of the aircraft in real time, and configured to generate, at regular time intervals, a dynamic priority table comprising a list of the active alerts and the associated priority level, and
a module for generating an alert message, when an alert is triggered, configured to generate, at regular time intervals, a dynamic message table comprising the messages corresponding to the active alerts and the associated priority level,
at least one display configured to display, to a pilot, at least the messages associated with the active alerts of highest priority level.

18. A device according to claim 17, in which the display is further configured to display a plurality of messages associated with active alerts and ordered by priority level.

19. A flight management system comprising the device according to claim 17.

20. A computer program product, said computer program comprising code instructions making it possible to perform the steps of the method according to claim 1.
